(19) United States
(12) Patent Application Publication
(10) Pub. No.: US 2010/0025199 A1
(43) Pub. Date: Feb. 4, 2010

(54) METHOD FOR APPLYING A MARKING TO A CONVEYOR BELT

(75) Inventor: Angelo Ditaranto, Arcisate (IT)

Correspondence Address: DARBY & DARBY P.C., P.O. BOX 770, Church Street Station, New York, NY, 10008-0770, US

(73) Assignee: FORBO SIEGLING GMBH, Hannover (DE)

(21) Appl. No.: 12/530,376

(22) PCT Filed: Feb. 12, 2008
(86) PCT No.: PCT/DE2008/000230

§ 371 Date: Sep. 8, 2009

(30) Foreign Application Priority Data
Mar. 8, 2007 (DE) 10 2007 011 580.8

(51) Int. Cl. B65G 15/30; B41M 5/24

(52) U.S. Cl. 198/846; 198/844.1; 204/157.15

(57) ABSTRACT

A method for applying a marking to a belt includes applying an electromagnetic radiation to a surface of the belt so as to mark the belt in at least one region of the belt, wherein the marking modifies at least one optical property of the belt according to a predetermined contoured marking and leaves mechanical and/or chemical properties in the at least one region substantially unchanged as compared with other regions of the belt.

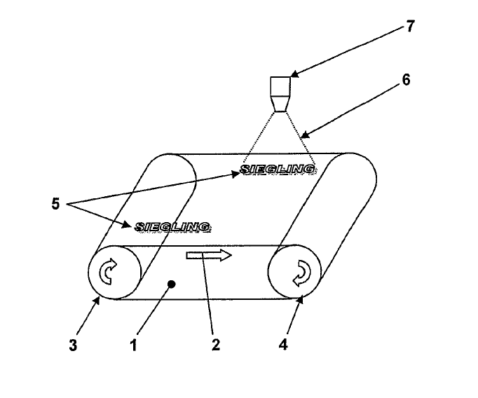

The present invention relates to a method for applying a marking to a belt, particularly a conveyor belt or drive belt, by applying energy to a surface of the belt, and to a belt provided with a marking according to said method.

It is known in the field to apply markings, advertisements, or position marks using printing techniques or by applying a coating material, in particular an adhesive film, which is permanently bonded to the surface of the belt by applying heat or through evaporation of solvents.

German Patent Application DE 196 49 746 A1 describes a conveyor belt composed of a plurality of individual, directly or indirectly interconnected conveyor belt segments which are provided with visual information. The conveyor belt segments are composed of flexible plastic or metal, the visual information being an integral part of such a segment. Complete units of information are vulcanized onto or engraved, etched or eroded into the conveyor belt segments. Alternatively, said units of information may be visually set off in machined recesses and depressions. The multipart conveyor belt segment includes, inter alia, a supporting member and a transparent cover member, for example of Plexiglas, the visual information being located therebetween.

Further, German Patent Application DE 198 05 934 A1 discloses a conveyor plate which is used in an endless modular conveyor belt and serves as an advertising vehicle. Unlike previous methods, where plastic films were adhesively bonded onto the conveyor plates or, in the case of conveyor plates made of transparent polycarbonate, into depressions provided therein, the approach here is to make a print on at least one surface of the conveyor plate using the screen-printing technique. To protect the print, it is coated with a transparent antistatic plastic film or shrinking membrane.

These horizontally circulating conveyor belts and information-carrying conveyor plates are used in airports for baggage handling, and are well-suited for advertising purposes, especially because travelers cannot escape the advertisement provided thereon.

In German Utility Model DE 200 10 296 U1, a vehicle carrying advertising information is provided in the form of an endless, non-modular belt which is composed of flexible material and moved in a circular path by motor-driven rollers. In this approach, the advertising message is applied to an advertising surface which is of transparent, reflective, fluorescent or holographic design and which, together with the belt, forms a homogeneous unit. The belt has signal pulse generators arranged parallel to the advertising surface, said signal pulse generators being in operative connection with audible public address systems and/or lighting or illumination systems via fixedly mounted signal pick-up devices. The advertising surface is applied using vulcanizing, adhesive bonding, printing, spraying, painting, engraving, etching, burning, or molding techniques, or may be visually set off by machined recesses and depressions. The belt may be used as a conveyor belt, fitness treadmill, or for escalator handrails.

In practice, however, such belts often have the disadvantage of being subject to wear, especially abrasive wear, caused by conveyed items, or also by diversion forces, so that the marking will gradually be worn away during service life.

Furthermore, in belts whose surface is structured, for example with elevations to increase static friction, contoured application of markings is only possible to a very limited extent. Rather, the visual appearance to the observer is blurred, so that a desired decorative effect or advertising effect can only be achieved to a limited extent, or that increased effort is required for automatic reading of position marks.

One might consider to remove a near-surface layer of the belt, for example by punching it out, and to replace it by a contoured marking. In practice, however, this idea would fail because of the considerable effort required to implement it. Also, a change in the material structure may impair the physical properties of the belt.

It is an object of the present invention to devise a simple way to provide such a belt with a sharply defined marking, regardless of the surface properties. A further object of the invention is to devise a belt provided with a marking using the method.

The first-mentioned object is achieved in accordance with the present invention by a method having the features of claim 1. Further details of the invention will become apparent from dependent claims 2 through 11.

Thus, the present invention provides a method in which the optical properties are modified according to the desired contoured marking by electromagnetic radiation acting on the belt surface in some regions, leaving the mechanical or chemical properties in the region of the marking substantially unchanged compared to the other regions of the belt. In this manner, a desired decorative or advertising effect, and also a technical marking, can be created with sharply defined contours and with highest accuracy even in a structured belt surface without the risk of impairing the other properties of the belt. In particular, the application of the marking does not involve forming a notch or other depression which could affect, for example, mechanical stability. Also, the application of the marking does not require unwanted application of an additional layer which would be subject to abrasion during service life, resulting in an impairment of the optical properties.

It is particularly advantageous if the marking is flush with the surface of the adjacent belt regions. This eliminates edges or steps in the transition region from the marking to the adjacent belt region, which were unavoidable in the prior art. Moreover, therefore, the tactile properties are the same in all belt regions, including the region of the marking.

The change in the optical properties could be limited to specific wavelengths which are invisible to the human eye and can only be perceived when illuminated by specific light sources, for example a UV light source, so as to allow application of latent features, such as in particular security and identification features. However, it is particularly convenient if the change in the optical properties is visible to the naked eye, which allows the observer to visually perceive the marking without any aids. Thus, it is possible, for example, to compare position marks to the desired positions of objects.

In principle, the marking may be in the form of a surface that is brighter or darker than the belt. However, it is particularly advantageous if a color change is achieved in the region of the marking, to thereby make it possible to implement nearly any desired color choice that is useful for technical or advertising purposes.

The electromagnetic radiation source is selected, and its parameters are set, according to the layer which forms the outer surface and whose material may contain, as a main component, thermoplastic or thermosetting materials, such as PVC, PU, PE, PET, PA, polyolefins, silicones, elastomers, but may also contain synthetic rubber, leather, natural rubber as components.

In a practical embodiment, it is particularly advantageous if the thermal energy is applied by a laser being scanned in a writing-type motion, i.e., in lines, across the surface to be provided with a marking, or if the electromagnetic radiation is applied by exposure through a stencil or mask, in which process the entire marking surface is simultaneously exposed to said radiation, thereby further reducing the required expenditure of time. Therefore, this method is also suitable for large-area markings.

Another particularly simple embodiment is achieved by destroying or changing the molecular structure of near-surface color pigments of the belt by means of the electromagnetic radiation, so that substantially no measurable changes of material properties will occur.

In a modified embodiment, which is also very promising, the exposure to electromagnetic radiation is carried out in a gas atmosphere to prevent undesired reactions of the belt material with the ambient air and to achieve a selective reaction in conjunction with the particular electromagnetic radiation.

The belt can in principle be used for any applications and may have corresponding properties. Moreover, it is particularly useful if the belt takes the form of a film or a fabric having an endless circulating or non-circulating design, which, in addition to transport and drive tasks, makes it also possible to implement, for example, coverings, rolling doors, or transport covers.

The second-mentioned object of devising a belt provided with a marking using the method is achieved in accordance with the present invention in that the surface of the belt has optical properties which are modified according to the desired contoured marking by electromagnetic radiation acting in some regions, while the mechanical and/or chemical properties in the region of the marking remain substantially unchanged compared to the other regions of the belt, so as to thereby enable technical and decorative markings to be created with a previously unknown contour definition even in a structured belt surface without the risk of impairing the other properties of the belt.

According to the present invention, a belt 1 can be embodied in different forms. To further illustrate the basic principle of the invention, one of these embodiments is shown in the drawing and described below. The drawing is a schematic perspective view of an endless polymer belt 1 designed as a conveyor belt which circulates in the direction of arrow 2 and is guided on two parallel rotatable rollers 3, 4. In order to apply a marking 5, an electromagnetic radiation 6 of a laser 7 acts on the surface of transparent belt 1 in some regions according to the desired contoured marking 5 in such a manner that the so-modified optical properties can be seen as a color change. At the same time, the mechanical and/or chemical properties in the region of marking 5 remain substantially unchanged compared to the other regions of belt 1.

1-12. (canceled)

13. A method for applying a marking to a belt comprising:
applying an electromagnetic radiation to a surface of the belt so as to mark the belt in at least one region of the belt, wherein the marking modifies at least one optical property of the belt according to a predetermined contoured marking and leaves mechanical and/or chemical properties in the at least one region substantially unchanged as compared with other regions of the belt.

14. The method as recited in claim 13, wherein the predetermined contoured marking is flush with a surface of at least one adjacent region of the belt.

15. The method as recited in claim 13, wherein the at least one optical property is modified so as to be visible to a naked eye.

16. The method as recited in claim 13, wherein the predetermined contoured marking includes a color change in an area of the desired contoured marking.

17. The method as recited in claim 13, wherein the belt includes at least one layer forming an outer surface, a material of the outer surface including one of a thermoplastic and thermosetting material.

18. The method as recited in claim 13, wherein the applying of the electromagnetic radiation is performed using a laser.

19. The method as recited in claim 13, wherein the applying the electromagnetic radiation includes exposing the electromagnetic radiation through a stencil or a mask.

20. The method as recited in claim 13, wherein the marking includes changing a molecular structure of near-surface color pigments of the belt by the electromagnetic radiation.

21. The method as recited in claim 13, wherein the applying the electromagnetic radiation is performed in a gas atmosphere.

22. The method as recited in claim 13, wherein the belt includes at least one of a film and a fabric.

23. The method as recited in 13, wherein the belt includes one of an endless circulating and a non-circulating belt.

24. A belt comprising:
a belt surface including at least one region having mechanical and/or chemical properties that are the same as compared with other regions of the belt surface and at least one optical property that is different as compared with other regions of the belt surface, the at least one optical property having been modified by an exposure to an electromagnetic radiation.

25. The belt as recited in claim 24, wherein the at least one region is flush with at least one adjacent region of the belt surface.

26. The belt as recited in claim 24, wherein the at least one optical property is visible to a naked eye.

27. The belt as recited in claim 24, wherein the at least one region includes a color change in an area of the at least one region.

28. The belt as recited in claim 24, wherein the belt includes at least one layer forming an outer surface, a material of the outer surface including one of a thermoplastic and thermosetting material.

29. The belt as recited in claim 24, wherein the at least one optical property includes a molecular structure of a near surface pigment.

30. The belt as recited in claim 24, wherein the belt includes one of a film and a fabric.

31. The belt as recited in claim 24, wherein the belt includes one of an endless circulating and a non-circulating belt.
